(19) United States
(12) Patent Application Publication
(10) Pub. No.: US 2006/0136987 A1
(43) Pub. Date: Jun. 22, 2006

(54) Communication apparatus

(75) Inventor: Masato Okuda, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/089,852

(22) Filed: Mar. 24, 2005

(30) Foreign Application Priority Data
Dec. 20, 2004 (JP) 2004-367591

(51) Int. Cl. H04L 9/00

(52) U.S. Cl. 726/1

(57) ABSTRACT

In a communication apparatus processing a packet transmitted/received by a device connected to a network, an identifying/processing policy storing portion stores a basic identifying policy and processing policy for determining an identification and processing of a packet corresponding to transmitted information from a device, a transmitted information extractor extracts the transmitted information, and a controller determines a rule for identifying and processing a received packet based on the identifying policy and the processing policy corresponding to the transmitted information extracted and prepares an identifying rule/processing rule setting table which indicates the rule. A packet processing identifies the received packet based on the identifying rule and processes the identified packet based on the processing rule.

### BACKGROUND OF THE INVENTION

1. Field of the Invention The present invention relates to a communication apparatus, and in particular to a communication apparatus which processes a packet transmitted or received (hereinafter, referred to as transmitted/received) by equipment (hereinafter, occasionally referred to as device) connected to a network.

Together with a recent development of a communication technology, e.g. household electrical appliances (devices) have become digitalized and networked, so that it is expected that the number of devices connected to a network increases more and more. An accurate setting of control information concerning packet processing such as QoS (Quality of Service), filtering and routing corresponding to a packet transmitted/received by each device to a communication apparatus such as a gateway apparatus, a router and a switch has become more and more important.

2. Description of the Related Art

Various kinds of control information such as an identifying rule and a processing rule of a packet have been set to a communication apparatus from a terminal connected to the communication apparatus with a serial interface and a terminal connected to the communication apparatus with Telnet. As for a User Interface (UI) at this time, a CLI (Command Line Interface) is used in many cases. Also, as the UI, a Web UI using a Web technology has been widely used, and provides a graphical interface to an administrator. In the CLI and the Web UI, the administrator manually sets the control information to the communication apparatus.

FIG. 24 shows a gateway apparatus 100A as a prior art communication apparatus. This gateway apparatus 100A is connected to a LAN 300_1 and the Internet 300_2. Devices 200_1-200_3 (hereinafter, occasionally represented by a reference numeral 200) are connected to the LAN 300_1. The devices 200 includes a TV receiver, a TV distribution server and a personal computer (PC) respectively, and their IP addresses are IP-A-IP-C.

The gateway apparatus 100A is provided with a packet processor 10, a setting table 11 and a man-machine interface 18. In the setting table 11, QoS corresponding to a transmitting source IP address, a distribution address, a port No. (not shown) etc. of a packet are set. The setting table 11 is prepared through the man-machine interface (CLI or Web UI) 18 by an administrator 500. The packet processor 10 stores a packet from the device 200 in a queue (not shown) according to its priority referring to the setting table 11, so that QoS processing giving a higher priority to a packet of a queue with a higher priority is performed. Accordingly, in order to accurately perform the QoS processing, the administrator is required to accurately input the IP address, the port No., the QoS and the like for every entry in the setting table 11.

FIG. 25 shows a gateway apparatus 100B as an example of another prior art communication apparatus. This gateway apparatus 100B is connected to the local network (LAN) 300_1 and the Internet 300_2. A local PC 210 and a remote PC 220 are respectively connected to the networks 300_1 and 300_2. The gateway apparatus 100B is provided with an external communication portion, a controller, an internal communication portion and a memory. The memory includes an IP/MAC correspondence table, an NAPT (Network Address and Port Translation) entry and a PF (Packet Filter) entry. The local PC 210 is composed of a recording portion including an IGD-capable communication application, a controller and a communication portion. The remote PC 220 is composed of a recording portion including a communication application, a controller and a communication portion.

For a registration of the NAPT entry, a UPnP IGD (Internet Gateway Device) function is used. The gateway apparatus 100B requires an IGD function, and the local PC 210 requires an IGD control function.

In the NAPT entry and the PF entry of the gateway apparatus 100B, setting information which enables the remote PC 220 to access the local PC 210 is registered. The setting information is transmitted to the gateway apparatus 100B from the local PC 210, and is registered in the NAPT entry, the packet filter entry having the same information as the NAPT entry of the gateway apparatus 100B and the like. Namely, the setting information is automatically set from the local PC 210. Thus, it becomes possible for the remote PC 220 to access the local PC 210 beyond the NAPT.

[Patent Document 1] Japanese Patent Application Laid-open No.2004-221879 (page 7, FIG. 1)

However, not only the above-mentioned gateway apparatus 100B is required to have a controller to automatically set the setting information but also the local PC 210 is required to have a function (IGD-capable communication application) exclusive for controlling the gateway apparatus 100B. Namely, e.g. a network-capable device such as a household electrical appliance which is expected to be widely available in the future is required to mount thereon a function having a purpose different from an original purpose of the device itself, which causes a cost increase.

Also, the local PC 210 is required to recognize an IP address or the like of the gateway apparatus 100B in order to notify the setting information to the gateway apparatus 100B. However, the recognition method is not described. It is supposed that the recognition of the IP address or the like is performed manually. Also, the method of setting information for accessing another device within the LAN 300_1 to the gateway apparatus 100B by the local PC 210 is described. However, by this method, the designation of the address or the like of the other device is not specified, and it is supposed to be performed manually. There is a possibility that a problem occurs due to a false setting by the manual setting, and it can be forecasted that maintaining/managing a home network which is being complicated and diversified more and more becomes a heavy load. Furthermore, since an address length assumes 128 bits in IPv6, it is forecasted that the load of the manual setting operation becomes heavier, and the risk of the false setting is increased.

Also, as for an IPv6 address using RFC 3041 Privacy Extension, the IP address periodically changes. Therefore, it is not practical to change the IP address of a QoS/Filtering rule as occasion arises. Furthermore, it is supposed that the same device is shared with a plurality of users and the setting registered in the communication apparatus varies with the user. In this case, every time the user is changed, a packet processing rule of the communication apparatus is required to be changed, which leads to a heavy load of the manual setting operation.

Also, in order to apply the concerned system for other purposes except the automatic registration of the NAPT entry and the FP entry, the function and information exclusive for performing the automatic registration is also required for the local PC 210. All of the devices connected to the LAN 300_1 require the exclusive function or information, which leads to a lack of flexibility.

### SUMMARY OF THE INVENTION

It is accordingly an object of the present invention to provide a communication apparatus which processes a packet transmitted/received by a device connected to a network, wherein control information (identifying rule and processing rule of packet) concerning the packet processing is automatically set (registered) without adding a specific function to the device.

In order to achieve the above-mentioned object, a communication apparatus according to the present invention comprises: an identifying/processing policy storing portion storing a basic identifying policy and processing policy for determining an identification and processing of a packet corresponding to transmitted information from a device; a transmitted information extractor extracting the transmitted information; a controller determining a rule for identifying and processing a received packet based on the identifying policy and the processing policy corresponding to the transmitted information extracted, and preparing an identifying rule/processing rule setting table which indicates the rule; and a packet processor identifying the received packet based on the identifying rule and processing the identified packet based on the processing rule.

FIG. 1 shows a principle of the communication apparatus according to the present invention, which shows a gateway apparatus as an example of a communication apparatus 100. A gateway apparatus 100 is connected to a LAN 300_1 and the Internet 300_2. Devices 200_1-200_3 (hereinafter, occasionally represented by a reference numeral 200) are connected to the LAN 300 1, and transmit advertisement messages 730_1-730_3 (hereinafter, occasionally represented by a reference numeral 730) or the like in addition to a transmission/reception of communication packets 720_1 and 720_2 (hereinafter, occasionally represented by a reference numeral 720). The packets 720 and the messages 730 include transmitted information 700 such as user information (user name or the like) of the device, device information (device name or the like), and service information (service name or the like).

The gateway apparatus 100 is provided with a transmitted information extractor 12, a controller 13, an identifying/processing policy storing portion 14, a packet processor 10 and an identifying rule/processing rule setting table 11.

In the identifying/processing policy storing portion 14, a basic identifying policy and processing policy (e.g. “identifying policy”=“packet whose destination is TV receiver”, and “processing policy”=“QoS (high priority)”) for identifying and processing the packet 720 received by the packet processor 10, corresponding to the transmitted information (e.g. device name/service name=“TV receiver”) from the device 200 are preset.

The transmitted information extractor 12 extracts the transmitted information 700 from the device 200. The controller 13 prepares the setting table 11 indicating the identifying rule and the processing rule of the packet transmitted/received by the device 200 based on the identifying policy and the processing policy corresponding to the transmitted information 700, by referring to the identifying/processing policy storing portion 14. The packet processor 10 receives the packet transmitted/received by the device 200, identifies the received packet based on the identifying rule, and processes the identified packet based on the processing rule. It is to be noted that the controller 13 may be provided with a device information analyzer 13a and a transmitted information retrieving/setting portion 13b, the device information analyzer 13a may analyze the transmitted information (device information) 700, and the transmitted information retrieving/setting portion 13b may set the identifying rule and the processing rule in the setting table 11 by referring to the identifying/processing policy storing portion 14.

Thus, it becomes possible to automatically determine the identifying rule and the processing rule of the packet (received by the packet processor 10) transmitted/received by the device 200 based on the transmitted information included in a message or the like transmitted by the device 200.

It is to be noted that the communication apparatus 100 of the present invention is not limited to the gateway apparatus but may be applied to a communication apparatus such as a router and a bridge which processes a packet.

Also, in the present invention according to the above-mentioned present invention, the transmitted information may comprise device information, service information, or user information of the device included in any of an advertisement message, a communication packet, and a control packet.

Thus, it is possible for the controller 13 to prepare the identifying rule and the processing rule of the packet corresponding to device information (e.g. device name), service information (e.g. TV distribution), and user information (e.g. user name) included in e.g. an advertisement message of UPnP.

Also, in the present invention according to the above-mentioned present invention, the identifying/processing policy storing portion may store the identifying policy and the processing policy concerning device information, service information, or user information corresponding to the transmitted information.

Thus, it becomes possible to acquire information (user information such as Windows (registered trademark) domain log-on, 802.1x, user ID or user name of e-mail) specifying the user of the device from a communication packet transmitted/received e.g. by the device, and to automatically set the processing rule of the packet the starting point or endpoint of which is the device, according to a user.

Also, in the present invention according to the above-mentioned present invention, the identifying policy may include a policy identifying a packet based on at least one of a transmitting source address, a destination address, a protocol type, a transmitting source port number, and a destination port number of the packet.

Thus, it becomes possible to identify a protocol type of a communication packet transmitted/received by a device or the like, and to automatically set the processing rule of the packet the starting point or endpoint of which is the device according to the protocol information.

Also, in the present invention according to the above-mentioned present invention, the processing policy may include a policy concerning at least one of a service quality class, filtering, and routing of the packet.

Also, in the present invention according to the above-mentioned present invention, the identifying rule/processing rule setting table may have at least one of a transmitting source address, a destination address, a protocol type, a transmitting source port number, and a destination port number value identified by the identifying policy as the identifying rule.

Thus, it becomes possible to specifically identify the received packet based on the transmitting source address, the destination address, the protocol such as IGMPIMLD, SIP, and RTSP, the transmitting source port No. and the destination port No. For example, even if the device does not explicitly transmit information such as service of the device itself, it becomes possible to automatically set the packet identifying rule and the processing rule corresponding to the service by identifying the protocol specific to the service or the application provided by the device. For example, it becomes possible to apply the processing rule of a high priority by determining that a terminal transmitting/receiving the SIP and the RTP is a VoIP terminal. Also, the address is not limited to an IP address, and by adding e.g. a MAC address to the identifying policy it is possible to automatically add the identifying rule of the MAC address and it is possible to automatically prescribe a MAC address filtering processing rule in e.g. the bridge.

Also, in the present invention according to the above-mentioned present invention, the identifying rule/processing rule setting table may have at least one of a service quality class, filtering, and a routing value of the packet as the processing rule.

Thus, it becomes possible to specifically process the received packet by a quality class (QoS), filtering (e.g. URL filtering), routing or the like.

Also, in the present invention according to the above-mentioned present invention, the communication apparatus may comprise a gateway apparatus, a router, a bridge, or a switch.

Namely, the communication apparatus of the present invention can be applied to an apparatus which identifies and processes a packet.

Also, in the present invention according to the above-mentioned present invention, the controller may delete from the identifying rule/processing rule setting table the identifying rule and the processing rule which have not been accessed for a predetermined time.

Thus, it becomes possible to reduce a memory capacity of the setting table which stores the identifying rule and the processing rule. Also, by reducing the memory capacity of the table, packet transfer throughput can be improved. Furthermore, it becomes possible to always keep the table in the latest state.

Also, the present invention according to the above-mentioned present invention may further comprise a notifying message generator notifying the identifying rule and the processing rule to another communication apparatus.

Thus, the identifying rule and the processing rule can be further set to another communication apparatus.

Also, in the present invention according to the above-mentioned present invention, the transmitted information extractor may receive the identifying rule and the processing rule from another communication apparatus, and the controller may prepare the setting table based on the identifying rule and the processing rule.

Furthermore, a communication apparatus according to the present invention comprises: an identifying/processing rule receiver receiving an identifying rule and a processing rule prepared based on an identifying/processing policy corresponding to transmitted information from a device, and preparing an identifying rule/processing rule setting table indicating a rule for identifying and processing a received packet based on the identifying rule and the processing rule; and a packet processor identifying the received packet based on the identifying rule and processing the identified packet based on the processing rule.

Thus, in the communication apparatus without the identifying/processing policy storing portion, it becomes possible to identify and to process the packet with the identifying rule/processing rule prepared based on the identifying/processing policy indicated by another communication apparatus.

Also, the present invention according to the above-mentioned present invention may further comprise a detailed information acquiring portion inquiring, of the device, an acquiring destination of the identifying policy and the processing policy corresponding to the transmitted information not stored in the identifying/processing policy storing portion, and acquiring the identifying policy and the processing policy corresponding to the transmitted information from the acquiring destination.

Thus, it becomes possible to acquire the identifying policy and the processing policy corresponding to transmitted information not registered in the identifying/processing policy storing portion.

Also, the present invention according to the above-mentioned present invention may further comprise a connecting device information storing portion associating a value indicated by the identifying rule with the transmitted information of the device, and a man-machine interface; the controller may convert the transmitted information of the device designated by the man-machine interface into a value of the identifying rule referring to the connecting device information storing portion, and may convert the value of the identifying rule into the transmitted information of the device to be provided to the man-machine interface.

Thus, a user can confirm, change or the like the information of the setting table based on the transmitted information (e.g. device name, products name or the like which can be recognized by the user) of the device without being conscious of a value (e.g. IP address or the like of device) indicated in the identifying rule, through a man-machine interface.

Also, the present invention according to the above-mentioned present invention may further comprise a transmitted information identifying condition table indicating an identifying condition of the transmitted information to be extracted; and the transmitted information extractor may extract the transmitted information based on the transmitted information identifying condition table.

Thus, it becomes possible to extract only necessary transmitted information, which eliminates waste of extraction.

Also, in the present invention according to the above-mentioned present invention, the condition may comprise a condition concerning device information or user information.

Thus, it becomes possible to identify the transmitted information based on the device or the user information such as the user name. Also, it becomes possible to specify a user who uses the device, and to apply the identifying rule and the processing rule corresponding to the user preset to the packet related to the concerned device. Also, when a single PC is shared with a plurality of users and a single user uses a plurality of PCs, it becomes unnecessary to set the IP address or the like of the PC to the gateway apparatus as occasion arises.

Furthermore, the present invention according to the above-mentioned present invention may further comprise a check table indicating that the transmitted information has already been extracted or is not required to be extracted; and the transmitted information extractor may extract the transmitted information based on the check table.

Thus, it becomes possible to extract only necessary transmitted information, which eliminates waste of extraction.

As described above, by the communication apparatus according to the present invention, it becomes possible to automatically set control information (identifying rule and processing rule (QoS control, Filtering control or the like)) concerning packet processing without adding a specific function to a device.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing a principle of a communication apparatus according to the present invention;

FIG. 2 is a block diagram showing an arrangement of an apparatus in an embodiment (1) of a communication apparatus according to the present invention;

FIG. 3 is a diagram showing an example of transmitted information in an embodiment (1) of a communication apparatus according to the present invention;

FIG. 4 is a diagram showing an example of a transmitted information identifying condition table in an embodiment (1) of a communication apparatus according to the present invention;

FIG. 5 is a diagram showing an example of an identifying/processing policy storing portion (device policy) in an embodiment (1) of a communication apparatus according to the present invention;

FIG. 6 is a diagram showing an example of an identifying rule/processing rule setting table (QoS) in an embodiment (1) of a communication apparatus according to the present invention;

FIG. 7 is a block diagram showing an arrangement of an apparatus in an embodiment (2) of a communication apparatus according to the present invention;

FIG. 8 is a diagram showing an operation example in an embodiment (2) of a communication apparatus according to the present invention;

FIG. 9 is a block diagram showing an arrangement of an apparatus in an embodiment (3) of a communication apparatus according to the present invention;

FIG. 10 is a diagram showing an operation procedure example in an embodiment (3) of a communication apparatus according to the present invention;

FIG. 11 is a diagram showing an example of detailed information in an embodiment (3) of a communication apparatus according to the present invention;

FIG. 12 is a diagram showing a format example of detailed information in an embodiment (3) of a communication apparatus according to the present invention;

FIG. 13 is a block diagram showing an arrangement of an apparatus in an embodiment (4) of a communication apparatus according to the present invention;

FIG. 14 is a diagram showing an example of a connecting device information storing portion in an embodiment (4) of a communication apparatus according to the present invention;

FIG. 15 is a block diagram showing an arrangement of an apparatus in an embodiment (5) of a communication apparatus according to the present invention;

FIG. 16 is a diagram showing an example of a transmitted information identifying condition table (protocol identification) in an embodiment (5) of a communication apparatus according to the present invention;

FIG. 17 is a diagram showing an example of a user check table in an embodiment (5) of a communication apparatus according to the present invention;

FIG. 18 is a diagram showing an example of an identifying/processing policy storing portion (user policy) in an embodiment (5) of a communication apparatus according to the present invention;

FIG. 19 is a diagram showing an operation procedure (user authentication in POP) example in an embodiment (5) of a communication apparatus according to the present invention;

FIG. 20 is a diagram showing an example of a setting table (with expiration timer) in an embodiment (6) of a communication apparatus according to the present invention;

FIG. 21 is a diagram showing an example of an identifying/processing policy storing portion (device policy and filtering) in an embodiment (7) of a communication apparatus according to the present invention;

FIG. 22 is a diagram showing an example of an identifying/processing policy storing portion (user policy and filtering) in an embodiment (8) of a communication apparatus according to the present invention;

FIG. 23 is a diagram showing an example of an identifying/processing policy storing portion (user policy and routing) in an embodiment (9) of a communication apparatus according to the present invention;

FIG. 24 is a block diagram showing an example (1) of a prior art communication apparatus; and

FIG. 25 is a block diagram showing an example (2) of a prior art communication apparatus.

### DESCRIPTION OF THE EMBODIMENTS

### Embodiment (1)

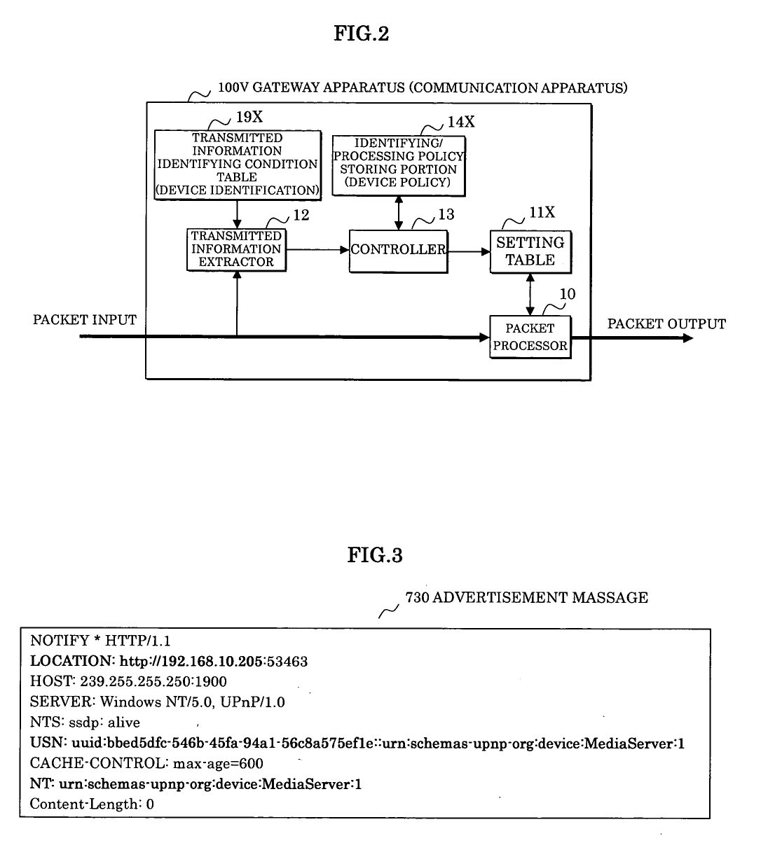

FIG. 2 shows an embodiment (1) of the communication apparatus of the present invention, which shows a gateway apparatus 100V as a communication apparatus. The gateway apparatus 100V is provided with a transmitted information extractor 12, a controller 13, a device policy storing portion 14X and transmitted information identifying condition table 19X in addition to a packet processor 10 and a setting table 11X.

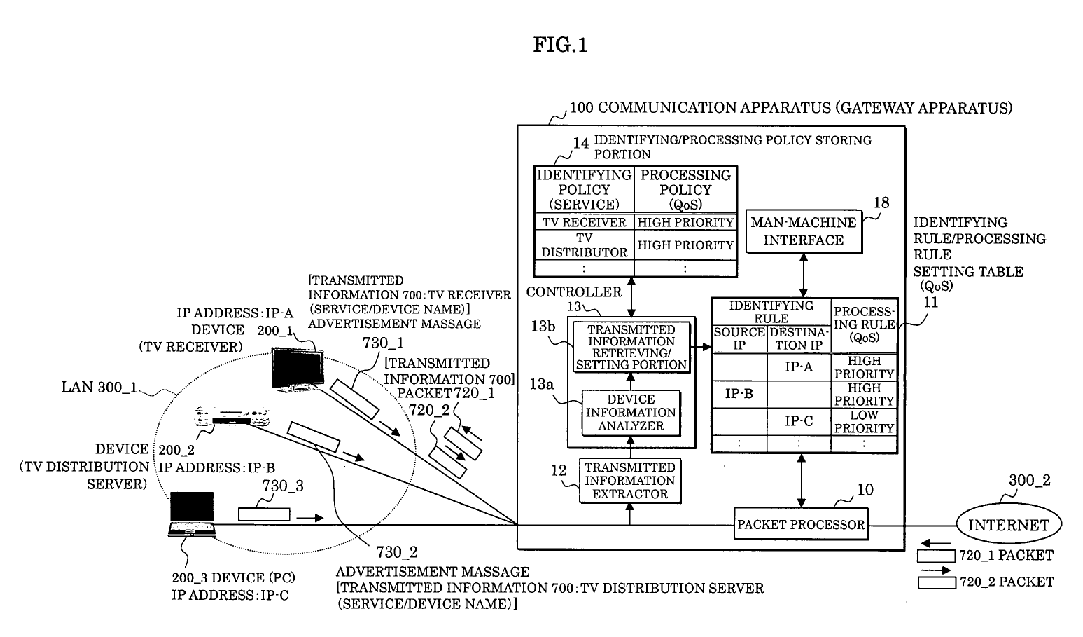

Hereinafter, the operation of the gateway apparatus 100V in a case where not the communication apparatus 100 but the gateway apparatus 100V is connected to the network shown in FIG. 1 and the device 200 supports UPnP.

FIG. 3 shows an advertisement message 730 transmitted by the device 200 when power is turned on and periodically. The advertisement message 730 indicates, as transmitted information, that a “USN (Unique Service Name) portion” or an “NT (Notification Type) portion” is a content distribution server (Media Server) whose transmitting source device is prescribed by the UPnP (urn: schemas-upnp-org), a “LOCATION portion” is a transmitting source IP address=“192.168.10.205”, and a “HOST portion” is a destination IP address=“239.255.255.250” and a destination port No.=“1900”.

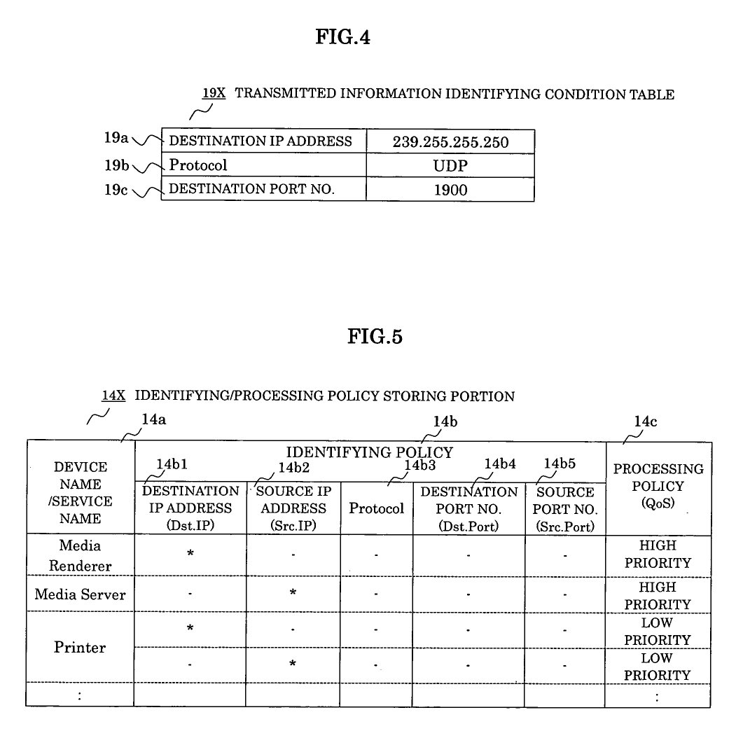

FIG. 4 shows the transmitted information identifying condition table 19X in IPv4. The table 19X indicates the identifying condition in which the transmitted information extractor 12 extracts the transmitted information 700. The identifying condition is a destination IP address 19a=“239.255.255.250”, a protocol 19b=“UDP”, and a destination port No. 19c=“1900”. The transmitted information extractor 12 provides the transmitted information 700 extracted (identified) to the controller 13.

The controller 13 extracts the device name or the service name from the transmitted information 700, retrieves the device policy storing portion 14X with the extracted device name or the service name as a key, and acquires the identifying policy and the processing policy of the packet transmitted/received by the device 200.

FIG. 5 shows the device policy storing portion 14X. The storing portion 14X is composed of a device name/service name 14a, an identifying policy 14b indicating a parameter required for identifying a packet corresponding to the device name/service name and a processing policy (QoS) 14c of the identified packet. The identifying policy 14b is further composed of a destination IP address 14b1, a transmitting source IP address 14b2, a protocol 14b3, a destination port No. 14b4 and a transmitting source port No. 14b5.

It is to be noted that while the processing policy 14c is designated by the “QoS” in this example, it can be designated by the “filtering”, the “routing” and the combination of these, as described later. Also, in the device policy storing portion 14X, a representative device name and service name are preliminarily registered as a default setting. Furthermore, preferably, a user may change contents through a man-machine interface, or may download the latest default value from the server on the network.

The controller 13 extracts the transmitting source device name/service name=“Media Server (content distribution server)” from the transmitted information 700. The controller 13 recognizes by referring to the storing portion 14X that the identifying policy 14b=“transmitting source IP address 14b2” corresponding to the device name/service name 14a=“Media Server” is indicated by “*” and the processing policy 14c=“QoS: high priority”. Furthermore, the controller 13 acquires the transmitting source IP address=“192.168.10.205” of the identifying policy that is a parameter value, from the location portion of the advertisement message 730 and the transmitting source IP address field (not shown) of the header of the packet which has transferred the advertisement message 730. Furthermore, the controller 13 sets “192.168.10.205” and “QoS: high priority” in the identifying rule/processing rule setting table 11X.

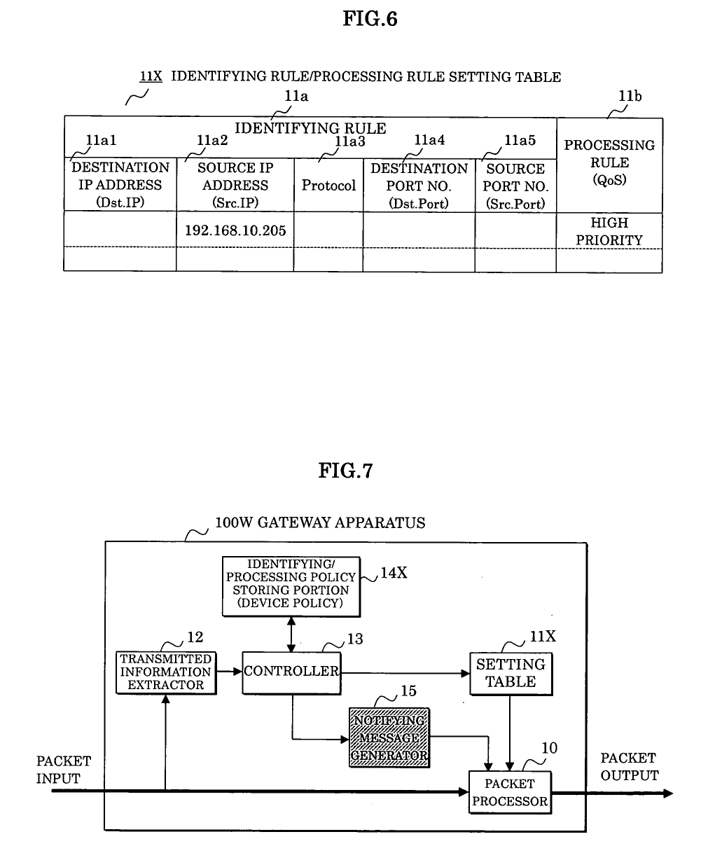

FIG. 6 shows the setting table 11X, which is composed of an identifying rule 11a and a processing rule 11b. The identifying rule 11a among these is further composed of a destination IP address 11a1, a transmitting source IP address 11a2, a protocol 11a3, a destination port No. 11a4 and a transmitting source port No. 11a5. In the setting table 11X, the transmitting source IP address 11a2=“192.168.10.205” and the processing rule (QoS) 11b=“high priority” are set. Namely, the setting table 11X designates the packet transmitted by the media server (transmitting source IP address=“192.168.10.205”) to be transferred and processed with the processing rule 11b=“high priority”.

In the same way as the conventional technology, the packet processor 10 stores the packet 720 (see FIG. 1) from the device (media server) 200 in a queue (not shown) corresponding to its priority by referring to the setting table 11X, and preferentially processes the packet with a higher priority.

As mentioned above, in the embodiment (1), it becomes possible to automatically set the identifying rule and the processing rule (QoS control) in the setting table 11X. It is to be noted that while in the processing policy 14c and the processing rule 11b of the embodiment (1), the QoS (“high priority” or “low priority” of packet) is prescribed, the communication apparatus of the present invention can automatically set a processing rule of the filtering control which performs packet “pass” and “discard”, the processing rule of the routing control designating “ISP” or the like, the processing rule of rewriting a ToS (Type of Service) field of the IP header or the like to a predetermined value, and the processing rule combining the above-mentioned rules.

### Embodiment (2)

FIG. 7 shows an embodiment (2) of a communication apparatus (gateway apparatus) 100W according to the present invention. This gateway apparatus 100W is different from the gateway apparatus 100V shown in the embodiment (1) in that a notifying message generator 15 is inserted between the controller 13 and the packet processor 10. In the embodiment (2), the communication apparatus notifies the identifying rule and the processing rule automatically set by the apparatus itself to a communication apparatus having no automatic setting functions of the packet identifying rule and the processing rule.

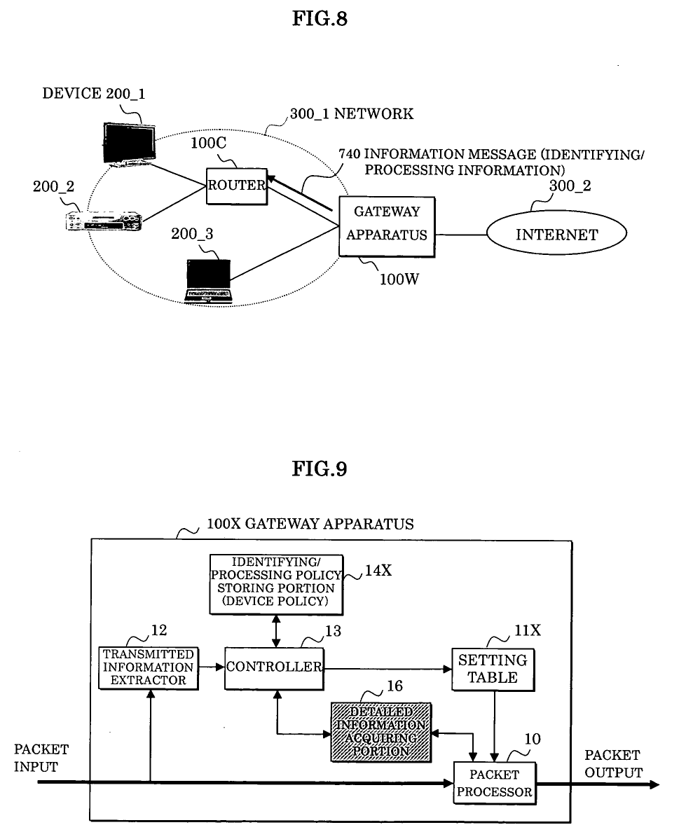

FIG. 8 shows an operation example of the embodiment (2). The network arrangement in the embodiment (2) is different from that shown in FIG. 1 in that a communication apparatus (router in FIG. 8) 100C having no automatic setting function of the packet identifying rule and the processing rule exists between the devices 200_1, 200_2 and the gateway apparatus 100W.

In the gateway apparatus 100W, the controller 13 provides the identifying rule and the processing rule automatically set to the notifying message generator 15. The notifying message generator 15 prepares a notifying message 740 including the identifying rule and the processing rule by using a predetermined protocol and a message format to be transmitted to the router 100C through the packet processor 10. The router 100C sets the received identifying rule and processing rule in the setting table 11X (not shown) of the router itself. The router 100C can perform the packet QoS control transmitted/received between the device (television transmission server) 200_2 and the device (television receiver) 200_1.

Namely, in the communication apparatus (router or the like) having no automatic setting function of the packet identifying rule and the processing rule, it becomes possible to set the packet identifying rule and the processing rule prepared based on the identifying policy and the processing policy shown in the above-mentioned embodiment (1).

It is to be noted that while the notifying destination of the notifying message (identifying rule and the processing rule) 740 is made the router 100C in FIG. 8, the gateway apparatus, a switch, and a management system (not shown) may be made a notifying destination. Also, not only the LAN 300_1 but also an external communication apparatus (router, switch, management system or the like) of the Internet 300_2 may be made the notifying destination. Also, the notifying message 740 may be either an SNMP command, an SOAP message or the like in addition to a setting file transmitted by using the CLI, ftp, tftp or the like. Also, the information of the communication apparatus which transmits the notifying message 740 can be acquired not only by a setting of an administrator but also by receiving an advertisement message when the ICMP Router Discovery (RFC 1256) is used and the router supports the UPnP. Furthermore, if the router supports the UPnP, the setting information can be notified by using the control function of the UPnP.

### Embodiment (3)

FIG. 9 shows an embodiment (3) of a communication apparatus (gateway apparatus) 100X according to the present invention. This gateway apparatus 100X is different from the gateway apparatus 100V shown in the embodiment (1) in that a detailed information acquiring portion 16 is inserted between the controller 13 and the packet processor 10. In the embodiment (3), when receiving a device name/service name (e.g. name of X company-made device) not registered in the device policy storing portion 14X, the gateway apparatus 100X inquires, of the device, an acquiring destination of the setting information (e.g. identifying policy and processing policy, or identifying rule and processing rule), and accesses the acquiring destination such as an X company-made server to acquire predetermined setting information.

It is to be noted that there are alternatives of setting a default value of the identifying rule and the processing rule in the setting table 11X without accessing the server, and of setting nothing in the setting table 11X.

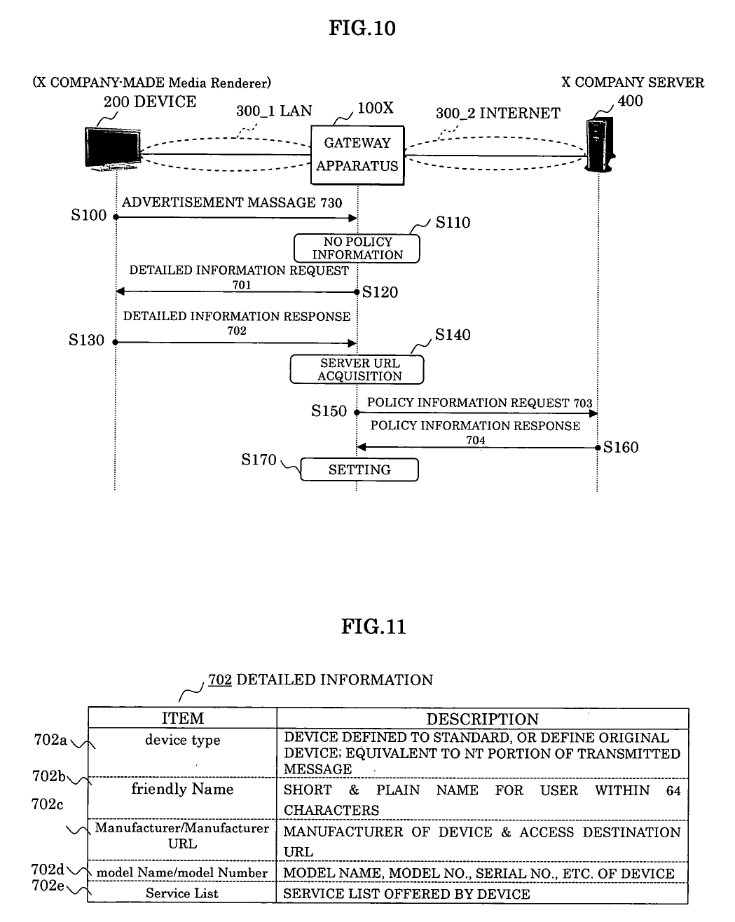

FIG. 10 shows an operation procedure example of the embodiment (3). In the embodiment (3), the gateway apparatus 100X is connected to the LAN 300_1 and the Internet 300_2. An X company-made device (Media Renderer) 200 and an X company-made server 400 are respectively connected to the LAN 300_1 and the Internet 300_2. The operation procedure example at this time will now be described.

Step S100: The device 200 transmits the advertisement message 730 including the transmitted information 700 (not shown). The gateway apparatus 100X receives this message 730.

Steps S110 and S120: In the gateway apparatus 100X, when no identifying policy and processing policy corresponding to the transmitted information (e.g. device name/service name) included in the advertisement message 730 exist in the device policy storing portion, the controller 13 requests the detailed information from the device 200 by referring to the transmitting source information (e.g. LOCATION portion (transmitting source address=“192.168.10.205”, TCP port No.=“53463”) of FIG. 2) of the device 200 within the advertisement message 730. The detailed information acquiring portion 16 transmits (accesses) a detailed information request (HTTP-GET) 701 requiring detailed information through the packet processor 10.

Step S130: The device 200 receives the detailed information request 701 and returns a detailed information response 702 including the detailed information to the gateway apparatus 100X.

FIG. 11 shows the detailed information included in the detailed information response 702, which includes a device type 702a, a friendly Name 702b, a Manufacturer/Manufacturer URL 702c, a model Name/model Number 702d and a Service List 702e.

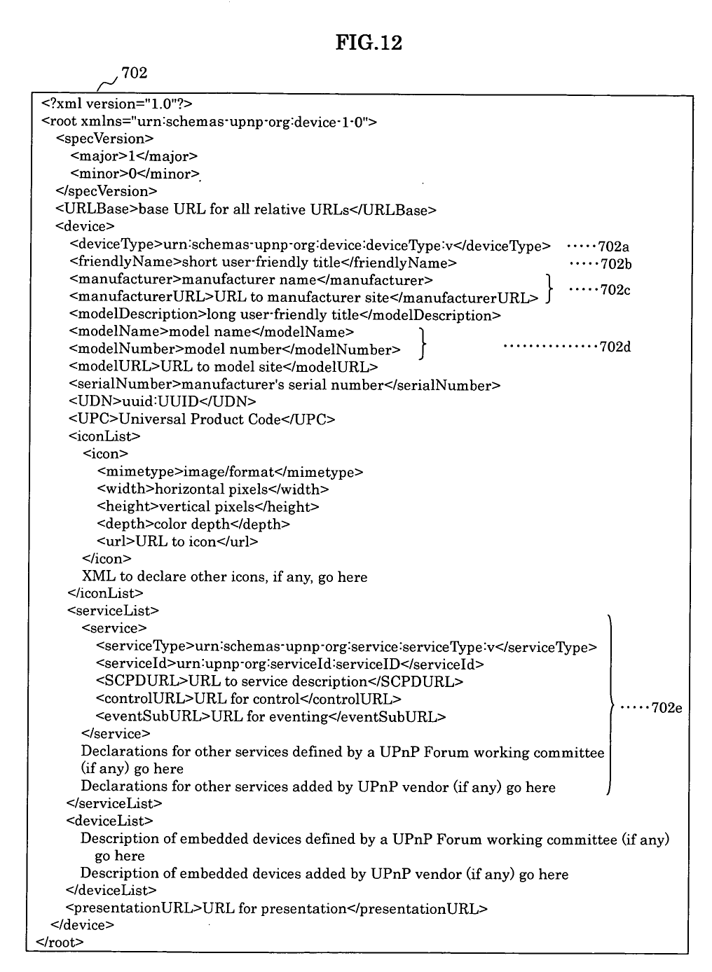

FIG. 12 shows a format example of the detailed information (Device Description) in the detailed information response 702. In <device> of the detailed information, the above-mentioned device type 702a, the friendly Name 702b, the Manufacturer/Manufacturer URL 702c, the model Name/model Number and the Service List 702e are included.

Steps S140-S150: In the gateway apparatus 100X, the detailed information acquiring portion 16 receives the detailed information response 702 through the packet processor 10, and provides the detailed information included in the detailed information response 702 to the controller 13. The controller 13 recognizes the information concerning the device 200 included in the detailed information, i.e. the URL of the X company-made server 400 which is an acquiring destination, from the manufacturer/manufacturer URL 702c, and transmits a policy information request 703 requesting the information concerning the identifying policy and processing policy to the server 400.

Step S160: The server 400 returns a policy information response 704. The information included in the policy information response 704 is equivalent to the entry registered in the device policy storing portion.

Step S170: In the gateway apparatus 100X, the detailed information acquiring portion 16 provides the identifying policy and the processing policy included in the policy information response 704 received through the packet processor 10, i.e. the parameter of the identifying rule and the processing rule to the controller 13. The controller 13 registers the identifying policy and the processing policy in the identifying/processing policy storing portion 14X, and then sets the identifying rule and the processing rule in the setting table 11X. The packet processor 10 identifies and processes received packet based on the setting table 11X.

Thus, it becomes possible for the gateway apparatus 100X to acquire the identifying policy and the processing policy corresponding to the transmitted information from a predetermined server.

### Embodiment (4)

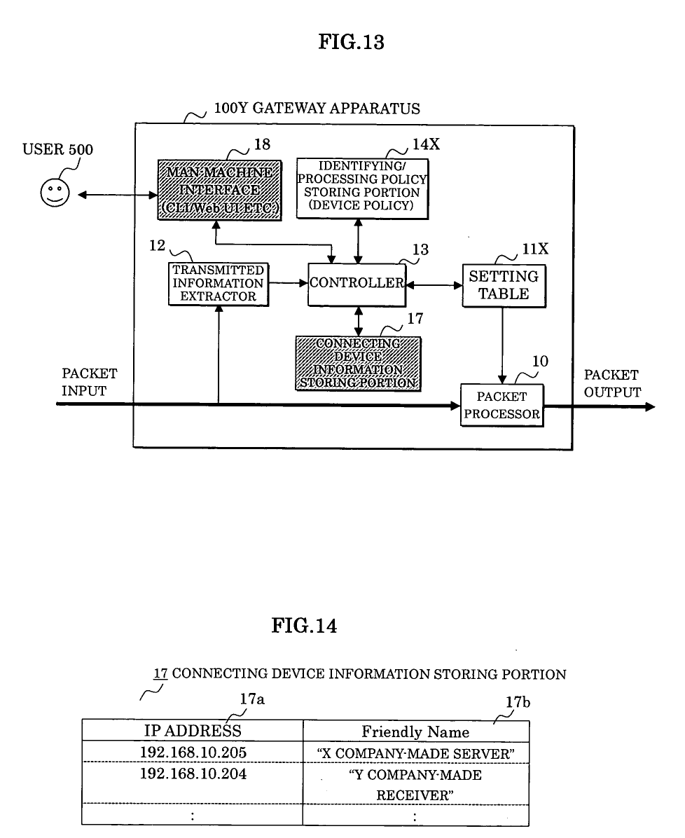

FIG. 13 shows an embodiment (4) of a communication apparatus (gateway apparatus) of the present invention. In the embodiment (4), an interface between a user 500 and a gateway apparatus 100Y is made user-friendly. The gateway apparatus 100Y is different from the gateway apparatus 100V of the embodiment (1) in that a connecting device information storing portion 17 and a man-machine interface 18 are connected to the controller 13. The man-machine interface 18 may be any of the CLI, the Web UI and the like.

FIG. 14 shows an example of the connecting device information storing portion 17, which indicates a correspondence relationship between an IP address 17a and a Friendly Name 17b (see FIG. 12). For example, the IP address 17a=“192.168.10.205” and the Friendly Name 17b=“X company-made server” which is a user-friendly manufacturer/device name corresponding to the IP address are registered in the storing portion 17.

The user 500 requests the controller 13 to confirm the setting table information through the man-machine interface 18. The controller 13 acquires the information for the request from the setting table 11X. Then, the controller 13 retrieves the connecting device information storing portion 17 with the IP address included in the information=“e.g. 192.168.10.205” as a key, and acquires the Friendly Name=“X company-made server” corresponding to the IP address=“192.168.10.205”. The controller 13 transmits the information of the setting table 11X in which the IP address 17a=“192.168.10.205” in the information is replaced with the corresponding Friendly Name 17b =“X company-made server” to the man-machine interface 18. The man-machine interface 18 displays the information.

Also, when the user 500 requests the setting change of the setting table 11X with the Friendly Name=“e.g. Y company-made receiver”, the man-machine interface 18 transmits the contents to the controller 13. Since the change contents include the Friendly Name, the controller 13 retrieves the connecting device information storing portion 17 with the Friendly Name=“Y company-made receiver” as a key, and acquires the corresponding IP address=“192.168.10.204”. The controller 13 changes the setting of the contents of the setting table 11X corresponding to the IP address=“192.168.10.204”.

Thus, the user can confirm/change the setting table information without being conscious of e.g. the IP address.

### Embodiment (5)

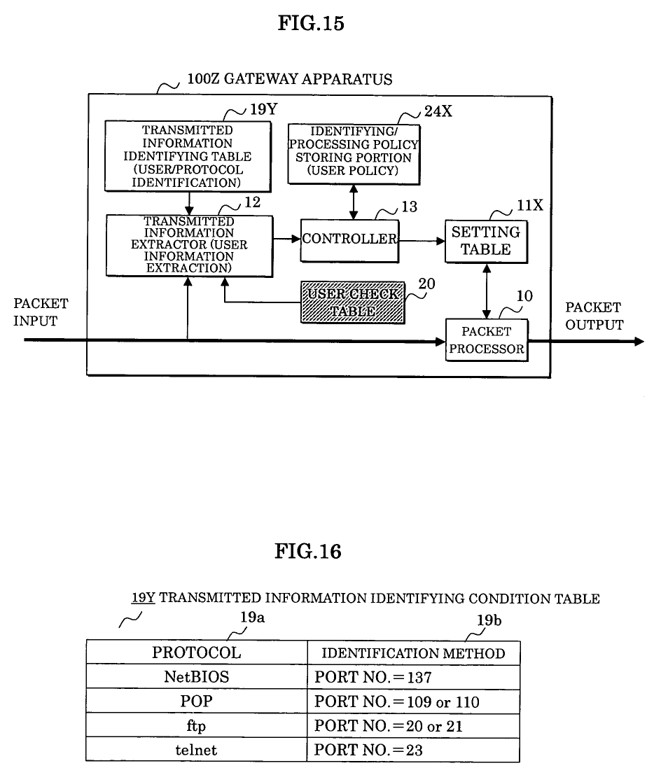

FIG. 15 shows an embodiment (5) of a communication apparatus (gateway apparatus) of the present invention. While the identifying/processing policy in the embodiment (1) is a policy concerning a device, the identifying/processing policy in the embodiment (5) is a policy concerning a user. A gateway apparatus 100Z is different from the gateway apparatus 100V shown in the embodiment (1) in that the transmitted information extractor 12, the identifying/processing policy storing portion 14, and the transmitted information identifying condition table 19Y respectively concern the user information instead of the device information, and a user check table 20 is connected to the transmitted information extractor 12.

FIG. 16 shows the transmitted information identifying condition table 19Y This table 19Y is composed of a protocol 19a and an identifying method 19b respectively indicating a protocol or the like having a possibility of including information which specifies a user name and its identification method. As an example of information which can specify the user name, protocol messages such as NetBIOS of Microsoft corporation, POP (Post Office Protocol), FTP (File Transfer Protocol) and telnet can be mentioned. Also, an authentication protocol such as PAP and CHAP in PPP and an authentication protocol such as 802.1X can be supposed to be used.

The transmitted information extractor (user information extraction) 12 extracts a message or a packet including one or more protocols or the like, i.e. including information which can specify a user by referring to the transmitted information identifying condition table 19Y and transmits the message to the controller 13.

At this time, the transmitted information extractor (user information extraction) 12 can have a function of refraining from transmitting all of the messages identified by the transmitted information identifying condition table 19Y to the controller 13. Namely, the transmitted information extractor 12 can transmit a message of a device which requires a user specification and which is further identified by a protocol to the controller 13, by referring to the user check table 20 indicating whether or not the specification of the user of the device is necessary.

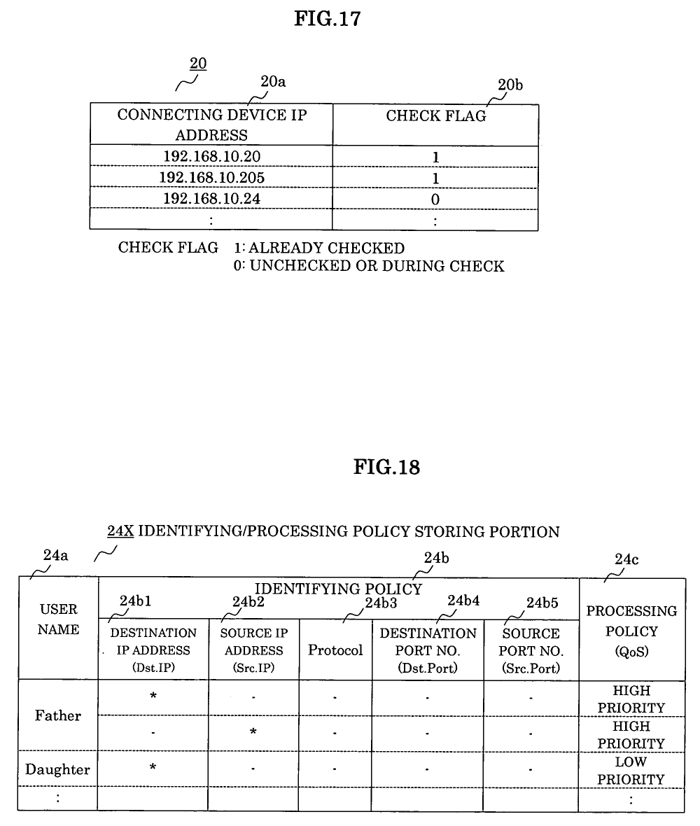

FIG. 17 shows the user check table 20, which is composed of a connection device IP address 20a and a check flag 20b. The controller 13 notifies the IP address of the device which “has completed the user specification” or “does not require the user specification” to the transmitted information extractor 12. The transmitted information extractor 12 sets a check flag with “1”, in the table 20 corresponding to the notified IP address, and prevents the transmitted information for specifying the user to which “1” is set from being extracted. Thus, it becomes possible not to extract unnecessary transmitted information. In e.g. the embodiment (1), it is possible not to extract the transmitted information for specifying the device by using the device check table (not shown) similar to the table 20.

The controller 13 sets the identifying rule/processing rule in the identifying rule/processing rule setting table 11X by referring to the identifying/processing policy storing portion (user policy) 24X.

FIG. 18 shows the identifying/processing policy storing portion (user policy) 24X, which is composed of a user name 24a, an identifying policy 24b (parameter required for identifying packet) corresponding thereto and a processing policy 24c. The identifying policy 24b is the same as the identifying policy 14b of the identifying/processing policy storing portion (device policy) 14X shown in FIG. 5. In the arrangement of the identifying/processing policy storing portion (user policy) 24X, the device name/service name 14a of the identifying/processing policy storing portion (device policy) 14X is replaced by the user name 24a. It is to be noted that the identifying/processing policy storing portion 24 is set by the user 500 through the man-machine interface (not shown).

The controller 13 receives the transmitted information from the transmitted information extractor 12, acquires the user name from the transmitted information, and acquires the IP address from the information (transmitting source IP address) of the IP header which has transferred the transmitted information.

However, the controller 13 can not always specify the user only by this information. The gateway apparatus of the present invention can specify the user by the user authentication.

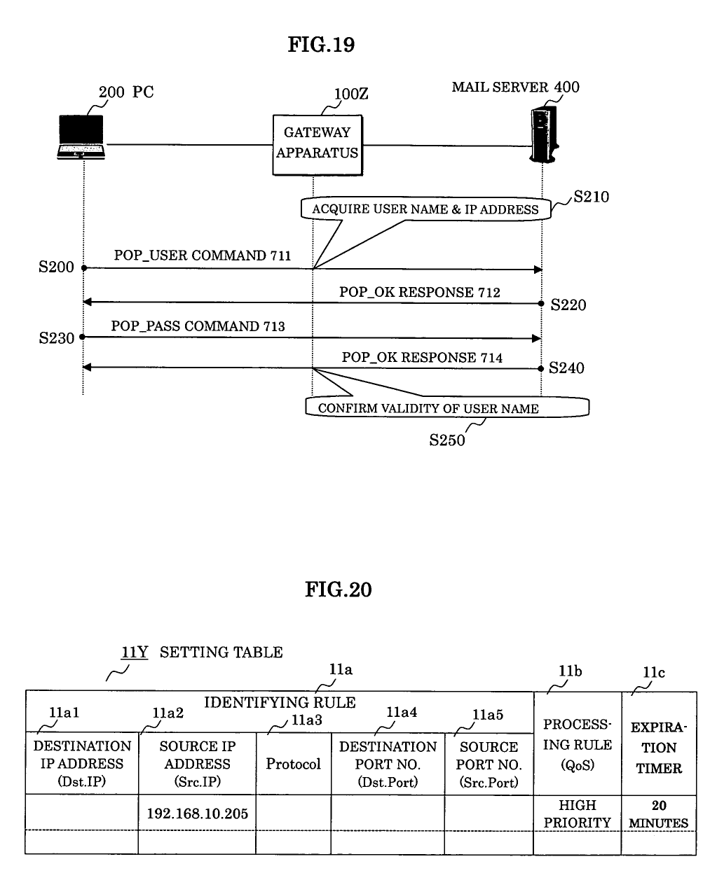

FIG. 19 shows an operation procedure example of the user authentication in the POP which is a mail reception protocol. By this operation procedure, the controller 13 can confirm validity of the user. The operation procedure example of the user authentication will now be described.

Steps S200 and S210: The device (PC) 200 transmits a POP_USER command 711 including a user name to a mail server 400. At this time, the gateway apparatus 100Z acquires the user name and the IP address corresponding thereto.

Step S220: The mail server 400 returns a POP_OK response 712 to the device 200.

Steps S230 and S240: The device (PC) 200 transmits a POP_PASS command 713 for authentication to the mail server 400, which returns a POP_OK response 714 to confirm (authenticate) of the validity of the user name.

Step S250: The gateway apparatus 100Z determines that the validity of the user name is confirmed by the POP_OK response 714.

When the specification of the user name is completed, the controller 13 retrieves the identifying/processing policy storing portion (user policy) 24X with the user name as a key, and acquires a parameter (identifying policy) of the identifying rule corresponding to the user name. The controller 13 sets the IP address value or the like acquired from the message received from the transmitted information extractor 12 corresponding to the parameter in the identifying rule of the setting table 11X, and sets the processing policy to the processing rule. The operation hereafter is the same as that of the embodiment (1).

In the above, the embodiment (5) for automatically setting the setting table 11X by extracting the user name included in the message of the protocol is described. In this embodiment (5), it is also possible to acquire and to set the identifying rule and the processing rule by detecting the protocol type itself. For example, an RTP (Real Time Transport Protocol) is used for a real-time communication such as moving images and voices. Therefore, a high QoS is requested for the transmission/reception device of this protocol. Accordingly, it is possible to detect a device receiving or transmitting the RTP, and to automatically set the packet of the device to be processed with a high priority.

### Embodiment (6)

FIG. 20 shows a setting table 11Y in an embodiment (6) of the communication apparatus (gateway apparatus) of the present invention. The embodiment (6) is different from the embodiment (1) only in the setting table 11Y. The setting table 11Y is different from the setting table 11X of the embodiment (1) in that an expiration timer 11c is added. In this expiration timer 11c, an expiration time is set to each entry of the setting table 11Y.

The controller 13 deletes an entry whose timer has expired from the setting table. The initialization of the expiration timer is performed when the concerned entry is accessed and the entry of the same contents is set by the controller. Thus, it becomes possible to achieve minimization of the setting table, to reduce a memory amount and to shorten a table retrieval time.

It is to be noted that while FIG. 20 shows an arrangement in which each entry has a timer value, a method of providing a flag bit (e.g. 1: with update, 0: no update) indicating presence/absence of update within a fixed period to each entry, and of deleting entries (flag=0) with no update for a fixed period collectively may be applied. Also, it is possible to apply the setting table 11Y to each of the embodiment.

Also, while the UPnP is used for discovering a device name/service name in the embodiments (1)-(6), DNS-SRV etc. prescribed by a Service Location Protocol (SLP) and RFC 2782 prescribed by another protocol such as RFC 2608, RFC 2609, and RFC 3111 may be used. Also, the embodiments (1)-(6) can be applied to both of a wired network and a wireless network.

### Embodiment (7)

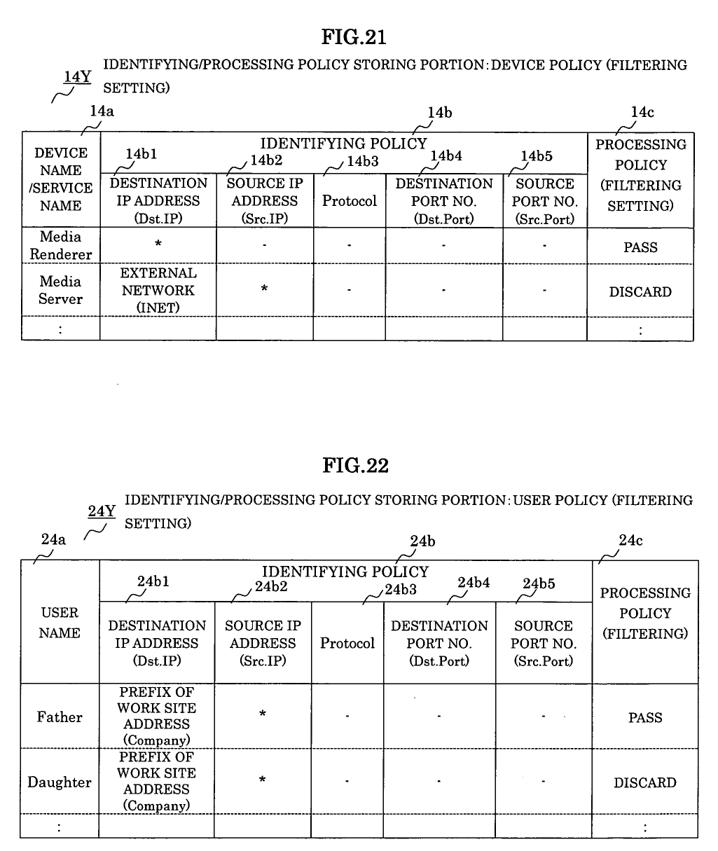

FIG. 21 shows an identifying/processing policy storing portion 14Y in an embodiment (7) of the communication apparatus (gateway apparatus) of the present invention. In the embodiment (7), only the identifying/processing policy storing portion 14Y and the identifying rule/processing rule setting table are different from those in the embodiment (1). The storing portion 14Y is different from the storing portion 14X of the embodiment (1) in that the processing policy 14c is a filtering policy instead of a QoS policy. By the processing policy, whether or not the received packet is discarded is designated. In the storing portion 14Y, it is set that the received packet whose destination is a “Media Renderer” is passed and the received packet whose transmitting source is a “Media Server” and whose destination is an “external network” is discarded. Similarly, the identifying rule/processing rule setting table (not shown) of the embodiment (7) is different from the identifying rule/processing rule setting table 11X of the embodiment (1) in that the processing rule 11b of the table 11X is a processing rule prescribed by the processing policy 24c (filtering) of the storing portion 14Y.

By this setting, it becomes possible to perform streaming of the contents from the Internet or the like to the Media Renderer, and not to flow the contents of the Media Server to the outside.

It is to be noted that while the identifying policy is composed of an IP address or the like in FIG. 21, filtering can be realized with a URL (Uniform Resource Locator) within an HTTP message used for a Web access being made the identifying policy.

### Embodiment (8)

FIG. 22 shows an identifying/processing policy storing portion 24Y in an embodiment (8) of the communication apparatus (gateway apparatus) of the present invention. In the embodiment (8), only the identifying/processing policy storing portion 24Y and the identifying rule/processing rule setting table (not shown) are different from those in the embodiment (7). The storing portion 24Y is different from the storing portion 14Y of the embodiment (7) in that the user name 24a is substituted for the device name/service name 14a. Namely, while the storing portion 14Y prescribes the policy concerning the device, the storing portion 24Y prescribes the policy concerning the user. In the storing portion 24Y, it can be set that the received packet whose user of the transmitting source device is “Father” and whose destination is “Company, a prefix of a work site address in this example” is passed, and the received packet whose user of transmitting source device is “Daughter” and whose destination is “Company” is discarded.

### Embodiment (9)

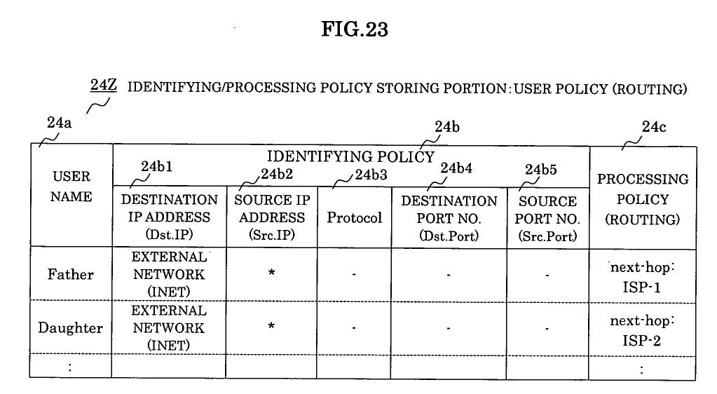

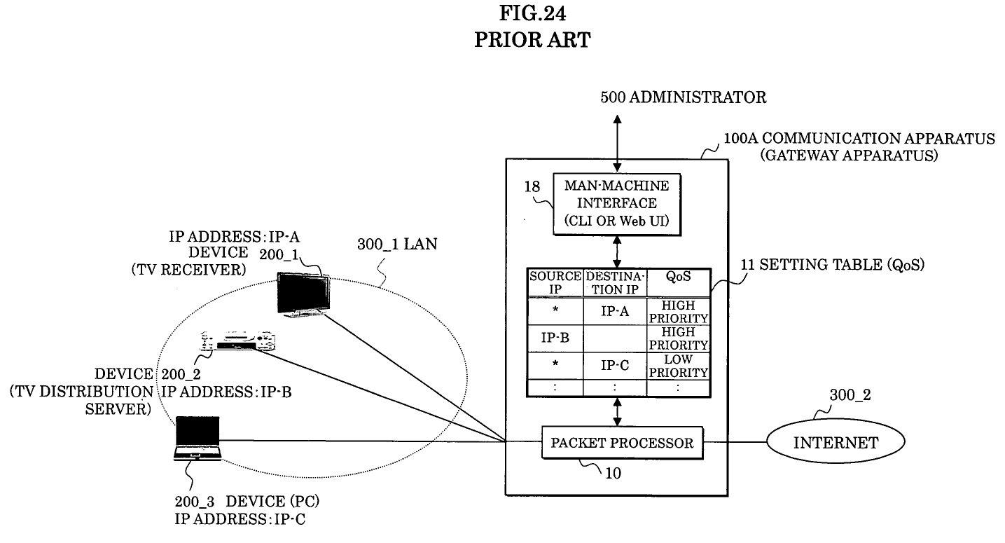

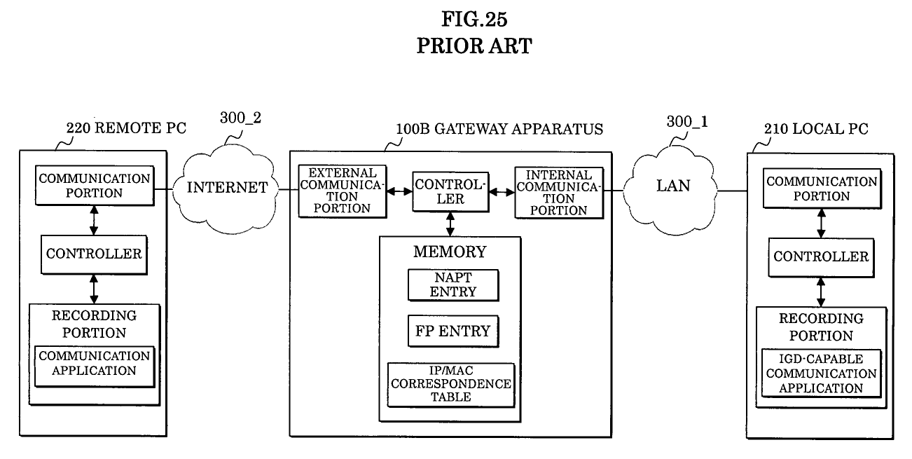

FIG. 23 shows an identifying/processing policy storing portion 24Z in an embodiment (9) of the communication apparatus (gateway apparatus) of the present invention. In the embodiment (9), only the identifying/processing policy storing portion 24Z and the identifying rule/processing rule setting table (not shown) are different from those in the embodiment (8). The storing portion 24Z is different from the storing portion 24Y of the embodiment (8) in that the processing policy 24c is the policy of routing instead of the policy of filtering. The identifying rule/processing rule setting table is different from the setting table (not shown) of the embodiment (8) in that the processing rule is the rule of routing instead of the rule of filtering.

The storing portion 24Z designates that the received packet whose user of the transmitting source device is “Father” and whose destination is an “external network” is routed to “ISP-1” and the received packet whose user of the transmitting source device is “Daughter” and whose destination is an “external network” is routed to ISP-2. Thus, it becomes possible to use a different ISP to be accessed for each user.

What is claimed is:

1. A communication apparatus comprising:
an identifying/processing policy storing portion storing a basic identifying policy and processing policy for determining an identification and processing of a packet corresponding to transmitted information from a device;
a transmitted information extractor extracting the transmitted information;
a controller determining a rule for identifying and processing a received packet based on the identifying policy and the processing policy corresponding to the transmitted information extracted, and preparing an identifying rule/processing rule setting table which indicates the rule; and
a packet processor identifying the received packet based on the identifying rule and processing the identified packet based on the processing rule.

2. The communication apparatus as claimed in claim 1, wherein the transmitted information comprises device information, service information, or user information of the device included in any of an advertisement message, a communication packet, and a control packet.

3. The communication apparatus as claimed in claim 1, wherein the identifying/processing policy storing portion stores the identifying policy and the processing policy concerning device information, service information, or user information corresponding to the transmitted information.

4. The communication apparatus as claimed in claim 1, wherein the identifying policy includes a policy identifying a packet based on at least one of a transmitting source address, a destination address, a protocol type, a transmitting source port number, and a destination port number of the packet.

5. The communication apparatus as claimed in claim 1, wherein the processing policy includes a policy concerning at least one of a service quality class, filtering, and routing of the packet.

6. The communication apparatus as claimed in claim 1, wherein the identifying rule/processing rule setting table has at least one of a transmitting source address, a destination address, a protocol type, a transmitting source port number, and a destination port number value identified by the identifying policy as the identifying rule.

7. The communication apparatus as claimed in claim 1, wherein the identifying rule/processing rule setting table has at least one of a service quality class, filtering, and a routing value of the packet as the processing rule.

8. The communication apparatus as claimed in claim 1, wherein the communication apparatus comprises a gateway apparatus, a router, a bridge, or a switch.

9. The communication apparatus as claimed in claim 1, wherein the controller deletes from the identifying rule/processing rule setting table the identifying rule and the processing rule which have not been accessed for a predetermined time.

10. The communication apparatus as claimed in claim 1, further comprising a notifying message generator notifying the identifying rule and the processing rule to another communication apparatus.

11. The communication apparatus as claimed in claim 1, wherein the transmitted information extractor receives the identifying rule and the processing rule from another communication apparatus, and the controller prepares the setting table based on the identifying rule and the processing rule.

12. A communication apparatus comprising:
an identifying/processing rule receiver receiving an identifying rule and a processing rule prepared based on an identifying/processing policy corresponding to transmitted information from a device, and preparing an identifying rule/processing rule setting table indicating a rule for identifying and processing a received packet based on the identifying rule and the processing rule; and
a packet processor identifying the received packet based on the identifying rule and processing the identified packet based on the processing rule.

13. The communication apparatus as claimed in claim 1, further comprising a detailed information acquiring portion inquiring, of the device, an acquiring destination of the identifying policy and the processing policy corresponding to the transmitted information not stored in the identifying/processing policy storing portion, and acquiring the identifying policy and the processing policy corresponding to the transmitted information from the acquiring destination.

14. The communication apparatus as claimed in claim 1, further comprising a connecting device information storing portion associating a value indicated by the identifying rule with the transmitted information of the device, and a man-machine interface;
the controller converting the transmitted information of the device designated by the man-machine interface into a value of the identifying rule referring to the connecting device information storing portion, and converting the value of the identifying rule into the transmitted information of the device to be provided to the man-machine interface.

15. The communication apparatus as claimed in claim 1, further comprising a transmitted information identifying condition table indicating an identifying condition of the transmitted information to be extracted;
the transmitted information extractor extracting the transmitted information based on the transmitted information identifying condition table.

16. The communication apparatus as claimed in claim 15, wherein the condition comprises a condition concerning device information or user information.

17. The communication apparatus as claimed in claim 1, further comprising a check table indicating that the transmitted information has already been extracted or is not required to be extracted;
the transmitted information extractor extracting the transmitted information based on the check table.
